(19) United States
(12) Patent Application Publication
(10) Pub. No.: US 2015/0156386 A1
(43) Pub. Date: Jun. 4, 2015

(54) IMAGE SENSOR, IMAGE SENSOR OPERATION METHOD, AND IMAGING APPARATUS

(71) Applicant: SONY CORPORATION, Tokyo (JP)

(72) Inventor: DAISUKE MIYAKOSHI, KANAGAWA (JP)

(21) Appl. No.: 14/551,532

(22) Filed: Nov. 24, 2014

(30) Foreign Application Priority Data
Dec. 3, 2013 (JP) 2013-250115

(51) Int. Cl. H04N 5/235; H04N 5/355

(52) U.S. Cl. CPC H04N 5/2352; H04N 5/355

(57) ABSTRACT

There is provided an image sensor including an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which is necessary for imaging an image into multiple time periods, and the accumulation unit accumulates the pixel signal generated by the imaging element and outputs the pixel signal accumulated in the necessary exposure time.

### CROSS REFERENCE TO RELATED APPLICATIONS

This application claims the benefit of Japanese Priority Patent Application JP 2013-250115 filed Dec. 3, 2013, the entire contents of which are incorporated herein by reference.

### BACKGROUND

The present technology relates to an image sensor, an image sensor operation method, and an imaging apparatus, and particularly to an image sensor an image sensor operation method, and an imaging apparatus which are capable of preventing a pixel signal from being saturated even when a Neutral Density (ND: light reduction) filter or the like is not used in imaging of a bright scene or the like.

A diaphragm or a shutter speed (exposure time) at the time of imaging is determined by a charge amount (sensitivity) photoelectrically converted in a pixel for a certain time and a saturated signal amount (Qs) which can be accumulated for each pixel.

In a case where the sensitivity of a pixel is increased such that an image signal can be acquired in a large amount even with a small amount of light for decreasing noise of a scene with low illuminance and a dark portion in a screen, it is necessary to increase the saturated signal amount at the same time.

However, it is difficult to increase the sensitivity and the saturated signal amount in a certain area at the same time due to the restricted pixel area, and it is necessary to perform design in which a balance between the sensitivity and the saturated signal amount is achieved.

Here, in an imaging element with a high sensitivity ratio with respect to the saturated signal amount, in a case where a bright scene that exceeds the saturated signal amount which can be accumulated in a pixel is imaged, an ND filter is inserted into the outside portion, an iris is stopped, or the shutter speed is increased (that is, the exposure time is shortened) so that the amount of light to be incident is decreased (see Japanese Unexamined Patent Application Publication No. 2002-135646).

### SUMMARY

However, in the above-described technique, since imaging procedures are complicated due to replacement of the ND filter, there is a concern that operability may be degraded. Further, the degree of freedom for photographic expression in, for example, adjustment of a depth of field using the iris (F value) or a manner of showing a subject that flows using the shutter speed, is restricted.

It is desirable to obtain an optimum image output even when the diaphragm and the shutter speed are freely set by a user without concerning the amount of light which is incident by dividing a set exposure time into multiple time periods and by adding pixel signals obtained in the divided exposure time periods.

According to an embodiment of the present technology, there is provided an image sensor including: an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which are necessary for imaging an image into multiple time periods, and the accumulation unit accumulates the pixel signal generated by the imaging element and outputs the pixel signal accumulated in the necessary exposure time.

The image sensor may further include a conversion unit that converts the pixel signal formed of an analog signal output by the imaging element into a digital signal, in which the accumulation unit may accumulate the pixel signal converted into the digital signal by the conversion unit.

The image sensor may further include an arithmetic unit that reads the pixel signal accumulated in the accumulation unit, adds the pixel signal converted into the digital signal by the conversion unit to the read pixel signal, and writes the pixel signal back to the accumulation unit when the pixel signal is generated by the imaging element for each of the divided exposure times.

The image sensor may further include a divided exposure frequency determining unit that determines the number of times of the division exposure based on a signal level of the pixel signal output by the accumulation unit.

In the image sensor, the divided exposure frequency determining unit may increase the number of times of the division exposure when the signal level of the pixel signal output from the accumulation unit is saturated in a case where a gain that amplifies the pixel signal is controlled to be minimum, the exposure time is controlled to be shortest, and a diaphragm is controlled to be minimum. In the image sensor, the exposure may be successively continued as a whole with each of the divided exposure time.

According to another embodiment of the present technology, there is provided a method of operating an image sensor which includes an imaging element that generates a pixel signal through photoelectric conversion with a variable exposure time, and an accumulation unit that accumulates the pixel signal generated by the imaging element, the method including: causing the imaging element to repeatedly generate the pixel signal through the photoelectric conversion for each of the divided exposure time periods obtained by dividing a necessary exposure time which is necessary for imaging an image into multiple time periods; and causing the accumulation unit to accumulate the pixel signal generated by the imaging element and output the pixel signal accumulated in the necessary exposure time.

According to still another embodiment of the present technology, there is provided an imaging apparatus including: an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which is necessary for imaging an image into multiple time periods, and the accumulation unit accumulates the pixel signal generated by the imaging element and outputs the pixel signal accumulated in the necessary exposure time.

According to the embodiments of the present technology, a pixel signal is generated by an imaging element through photoelectric conversion with a variable exposure time, the pixel signal generated by the imaging element is accumulated by an accumulation unit, the pixel signal is repeatedly generated by the imaging element through the photoelectric conversion for each of the divided exposure time periods obtained by dividing a necessary exposure time which is necessary for imaging an image into multiple time periods, the pixel signal generated by the imaging element is accumulated by the accumulation unit and the pixel signal accumulated in the necessary exposure time is output.

According to the embodiments of the present technology, it is possible to image an optimal image even when a gain, a shutter speed, and a diaphragm are freely set by a user without considering the amount of incident light.

### BRIEF DESCRIPTION OF THE DRAWINGS

FIG. 1 is a diagram describing a configuration of an embodiment of an imaging apparatus to which the present technology is applied;

FIG. 2 is a diagram describing a specific configuration example of an imaging element of FIG. 1;

FIG. 3 is a diagram describing a configuration example of a light receiving element constituting a light receiving element array of FIG. 2;

FIG. 4 is a timing chart describing an operation of the imaging element;

FIG. 5 is a flowchart describing image processing;

FIG. 6 is a diagram describing an operation of the imaging element in the image processing;

FIG. 7 is a diagram describing an operation at the time of dividing the exposure time;

FIG. 8 is a flowchart describing exposure control processing;

FIG. 9 is a diagram describing the exposure control processing; and

FIG. 10 is a diagram describing a configuration example of a general-purpose personal computer.

### DETAILED DESCRIPTION OF EMBODIMENTS

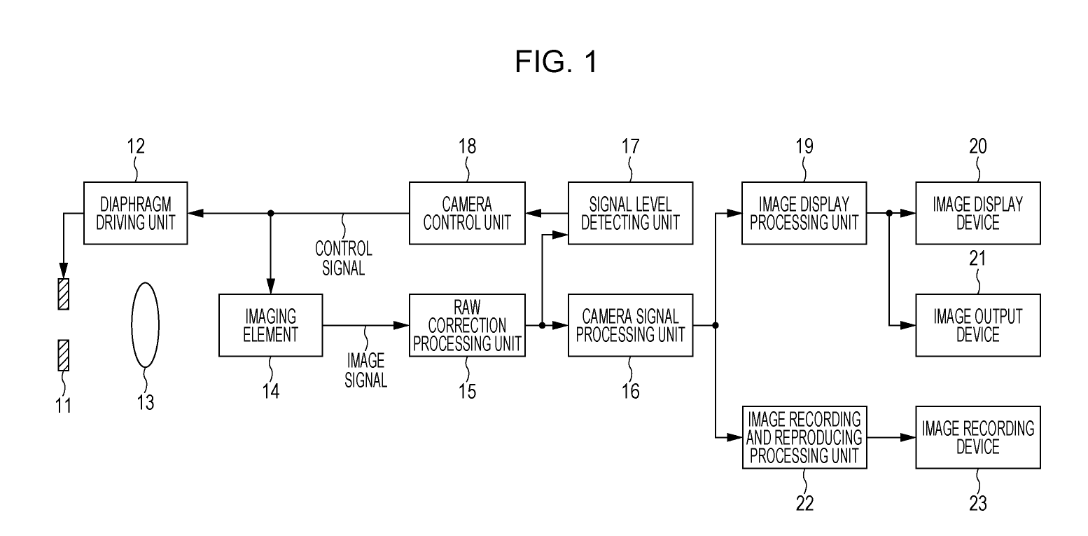

Configuration example of imaging apparatus FIG. 1 is a block diagram showing a configuration example of an embodiment of an imaging apparatus to which the present technology is applied.

The imaging apparatus of FIG. 1 includes a diaphragm mechanism unit 11, a diaphragm driving unit 12, a lens portion 13, an imaging element 14, a RAW correction processing unit 15, a camera signal processing unit 16, a signal level detecting unit 17, a camera control unit 18, an image display processing unit 19, an image display device 20, an image output device 21, an image recording and reproducing processing unit 22, and an image recording device 23.

The diaphragm mechanism unit 11 is a mechanism which operates to vary the diameter of a diaphragm opening portion by moving a plurality of blade-like mechanisms and adjusts the amount of light incident to the imaging element 14 through an operation for changing the diameter of an opening portion by a control signal from the diaphragm driving unit 12.

The lens portion 13 is formed of a lens group constituting an imaging optical system, and performs focus adjustment, and zoom adjustment if necessary.

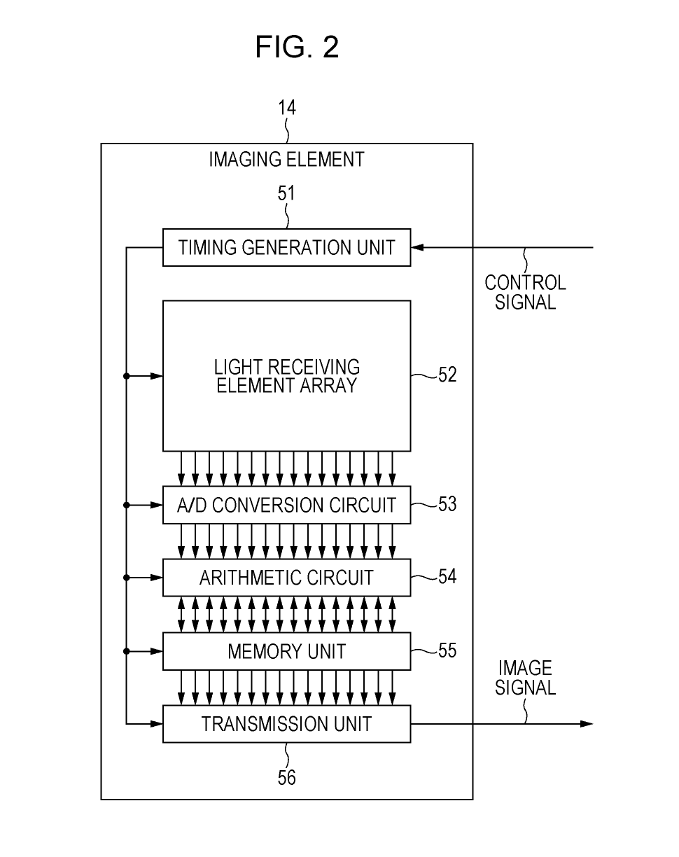

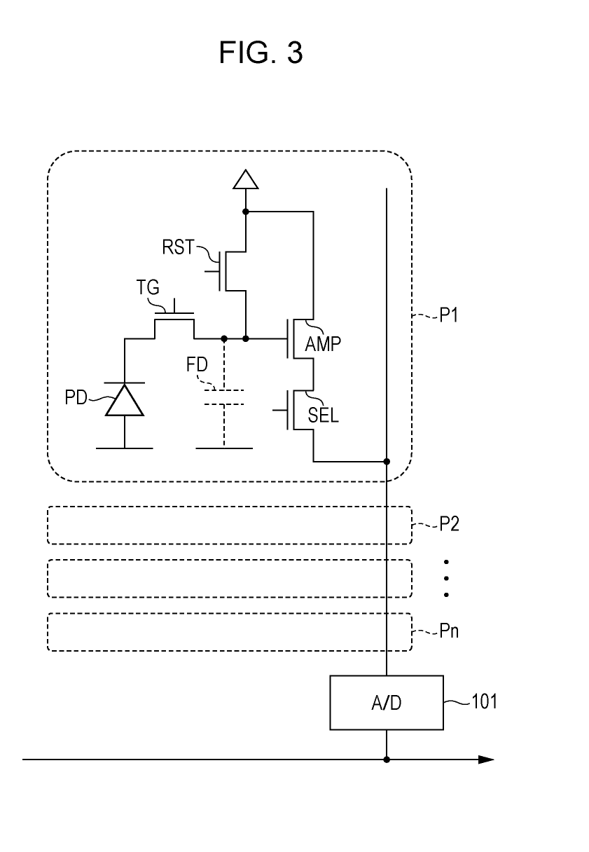

The imaging element 14 performs photoelectric conversion on light focused by the lens portion 13 using light receiving elements P1 to Pn (FIG. 3) arranged in a two-dimensional shape on the light receiving element array (FIG. 2), generates a pixel signal by converting light into an electrical signal, and outputs the pixel signal to the RAW correction processing unit 15 as an image signal formed of a pixel signal of a plurality of pixels. In addition, the internal structure of the imaging element 14 will be described in detail with reference to FIG. 2.

The RAW correction processing unit 15 corrects production tolerance of the image quality in a plane with regard to a pixel defect or a strain due to the lens portion 13 of the image signal output from the imaging element 14 and adjusts a black level and a white level according to a level diagram of a subsequent signal processing. The RAW correction processing unit 15 corrects the production tolerance of the image quality and supplies the image signal in which the black level and the white level are adjusted to the camera signal processing unit 16 and the signal level detecting unit 17.

The camera signal processing unit 16 performs camera signal processing such as pixel interpolation processing, color correction processing, edge correction, gamma correction, and resolution conversion with respect to the image signal supplied from the RAW correction processing unit 15 and outputs the image signal to the image display processing unit 19 and the image recording and reproducing processing unit 22.

The signal level detecting unit 17 supplies information such as an integral value of the entire screen, a signal level of the brightest portion, and a histogram showing distribution of the signal level to the camera control unit 18 by calculating the signal level of each pixel signal constituting image signals in an effective pixel area.

The camera control unit 18 performs feedback control by supplying a control signal to the diaphragm driving unit 12 and the imaging element 14 to obtain an optimal signal level of the image signal based on information such as a current image signal supplied from the signal level detecting unit 17, a current state (F value) of an iris (opening degree of a diaphragm), the shutter speed, a gain, and the number of times of division of the exposure time. Further, the camera control unit 18 can perform a manual operation for feedback based on the iris, shutter speed, and gain intentionally set by the user. Furthermore, the number of times of division of the exposure time will be specifically described later.

The image display processing unit 19 generates, based on an image signal supplied from the camera signal processing unit 16 and the image recording and reproducing processing unit 22, an image signal for display on the image display device 20 and an image signal for an output by the image output device 21.

The image display device 20 is configured of, for example, a liquid crystal display (LCD) or an organic electroluminescence (EL), and displays a camera-through image during imaging and a reproduced image of an image recorded in the image recording device 23.

The image output device 21 has a data format in conformity with a general video output standard such as High Definition Multimedia Interface (HDMI, registered trademark) and a connector, and outputs the camera-through image during imaging and the reproduced image recorded on the image recording device 23 to an external television or the like.

The image recording and reproducing processing unit 22 performs a compression encoding process on the image signal supplied from the camera signal processing unit 16 using an encoding system of an image such as a Moving Picture Experts Group (MPEG), performs a decompression decoding process on the encoded data of the image supplied from the image recording device 23, and outputs the data to the image display processing unit 19.

The image recording device 23 is a randomly accessible medium such as a semiconductor memory, for example, a Hard Disk Drive (HDD) or a flush memory, or an optical disk such as a Digital Versatile Disk (DVD), and is a continuously accessible medium such as a Digital Video (DV) tape, and records or reads an image signal on which the compression encoding process is performed.

Configuration example of imaging element Next, the configuration example of the imaging element 14 will be described in detail with reference to FIG. 2.

The imaging element 14 includes a timing generation unit 51, a light receiving element array 52, an Analog/Digital (A/D) conversion circuit 53, an arithmetic circuit 54, a memory unit 55, and a transmission unit 56.

The timing generation unit 51 supplies a timing control signal controlling operation timing of the respective blocks of the imaging element 14 based on the control signal supplied by the camera control unit 18.

The light receiving element array 52 is an aggregate of the light receiving elements P1 to Pn arranged in a two-dimensional shape formed of rows and columns. The light receiving element array 52 sequentially transfers the electric signal generated through photoelectric conversion caused by light being received by respective light receiving elements P1 to Pn arranged in a two-dimensional shape to the A/D conversion circuit 53 as a pixel signal for each column.

The A/D conversion circuit 53 converts a pixel signal formed of an analog signal which is output from the light receiving element array into a pixel signal of a digital signal for each column. The A/D conversion circuit 53 is configured of a follow-up comparison type A/D converter or the like, sequentially compares a counter value that counts up by one digital value per one clock with an analog input signal, stops the counter value when the value finds a match through a comparator, and outputs the value as a pixel signal formed of a digital signal.

The arithmetic circuit 54 writes a signal from the A/D conversion circuit 53 directly on the memory unit 55 to be accumulated or adds the signal from the A/D conversion circuit 53 to a pixel signal accumulated in the memory unit 55 and the result is accumulated in the memory unit 55 again.

The memory unit 55 performs an operation of reading out a pixel signal to the arithmetic circuit 54, and an accumulating operation of writing the arithmetic result of the arithmetic circuit 54, and a transferring operation of sequentially sending the signal to the transmission unit 56 based on the timing control signal supplied from the timing generation unit 51.

The transmission unit 56 transfers a plurality of pixel signals read from the memory unit 55 to the RAW correction processing unit 15 (FIG. 1) as image signals according to the control signal from the timing generation unit 51.

Configuration example of light receiving element Next, the configuration example of the light receiving element constituting the light receiving element array 52 will be described with reference to FIG. 3. Further, the light receiving element shown in FIG. 3 has a normal format configured of four transistors, but may have another configuration.

The light receiving elements P1 to Pn have the same configurations as each other, and are configured of a photodiode PD, a transfer transistor TG, a floating diffusion FD, a reset transistor RST, an amplifier transistor AMP, and a selection transistor SEL. Further, an A/D conversion circuit 101 is provided on a transfer line of the light receiving elements P1 to Pn arranged in the vertical direction.

In the photodiode PD, a cathode is connected to the transfer transistor TG, the charge which is an electric signal generated through photoelectric conversion according to light receiving is accumulated, and the charge is output to the floating diffusion FD according to the opening and closing of the transfer transistor TG.

The transfer transistor TG constitutes a transfer gate by opening and closing based on the transfer signal and transfers the charge accumulated in the photodiode PD to the floating diffusion FD.

The floating diffusion FD is a capacitor area formed with wiring capacity, accumulates the charge transferred from the photodiode PD through the transfer transistor TG, and supplies the charge to a gate of the amplifier transistor AMP.

The reset transistor RST configures a reset gate that opens and closes based on a reset signal and discharges the charge accumulated in the floating diffusion FD when turned ON. Further, the reset transistor RST discharges the charge accumulated in the floating diffusion FD and the charge accumulated in the photodiode PD to realize a reset operation when turned ON together with the transfer transistor TG.

The amplifier transistor AMP amplifies the power supply voltage based on the charge amount to be output as a pixel signal by opening and closing when the charge accumulated in the floating diffusion FD is input to the gate.

The selection transistor SEL constitutes a select gate that opens and closes based on a selection signal and outputs the pixel signal amplified by the amplifier transistor AMP to the A/D conversion circuit 101 when turned ON.

Further, in FIG. 3, one A/D conversion circuit 101 is provided for each column, but in some cases one A/D conversion circuit 101 is provided for a plurality of columns or a plurality of A/D converters are provided in one column, thus it is possible to speed up processing by increasing the configuration ratio of the A/D converter with respect to the column.

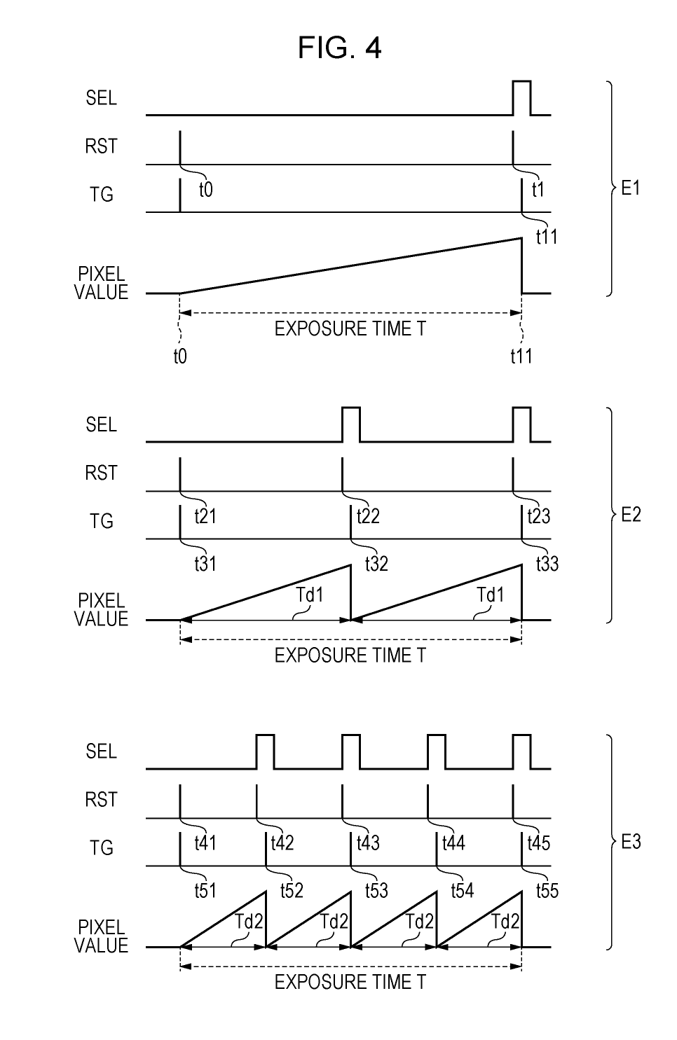

In regard to exposure timing Next, the exposure timing in the imaging element 14 will be described with reference to the timing chart of FIG. 4.

First, the exposure timing in a normal operation will be described with reference to the timing chart shown for an operation E1. Further, in FIG. 4, operations E1 to E3 represent the timing of a selection signal SEL, a reset signal RST, and a transfer signal TG, and a pixel value accumulated in the photodiode PD from the upper side, and the horizontal axis represents time. Therefore, at the timing in which the selection signal SEL, the reset signal RST, and the transfer signal TG are Hi, the selection transistor SEL, the reset transistor RST, and the transfer transistor TG in FIG. 3 are turned ON, but the respective signals are turned OFF at another timing.

That is, the reset transistor RST and the transfer transistor TG of FIG. 3 are simultaneously turned ON at a time t0, and the photodiode PD and the floating diffusion FD are reset at the same time by the reset transistor RST and the transfer transistor TG being turned OFF immediately after the ON state and then set to a state in which the accumulation of the charge can be initiated. Therefore, as shown at times t0 to t1 in a waveform of the fourth stage, the charge generated through the photoelectric conversion is accumulated as the pixel signal in the photodiode PD according to the time by light reception occurring from the time t0 to the time t1.

Next, at the time t1 near a time t11 at which a preset exposure time T has passed, the selection transistor SEL is turned ON, a pixel signal formed of an analog signal is set to be converted into a digital signal by the A/D conversion circuit 101, the reset transistor RST is temporarily turned ON, the charge gradually accumulated in the floating diffusion FD is reset again by a dark current, and the pixel signal at this time is converted into a digital signal as a reset value.

Next, at the time t11 of the second stage, the transfer transistor TG is turned ON, the charge accumulated in the photodiode PD is transferred to the floating diffusion FD, and then analog-digital conversion is performed thereon. Switch noise (kT/C noise) applied at the time when the reset transistor RST is turned OFF is cancelled through subtraction (CDS: correlated double sampling) of two values obtained in states in which the transfer transistor TG is turned ON and OFF so that an excellent pixel signal with less noise can be obtained.

Next, the exposure timing when the pixel signal is read with the exposure time T being divided into two time periods will be described with reference to the operation E2. That is, the charge of the photodiode PD is released once, the accumulation is continued by performing the typical readout sequence in the middle of the preset exposure time T, and thus, it is possible to continue exposure successively with the whole unit. It is possible to handle the charge in an amount double that of the accumulated charge in the photodiode PD and the floating diffusion FD by the charge accumulated in the photodiode PD being transferred to the floating diffusion FD in the middle of the exposure time.

Moreover, here, the above-described typical readout sequence is a sequence in which the selection transistor SEL is turned ON, the reset value of the floating diffusion FD is converted into the digital signal by turning ON the reset transistor RST, and the pixel signal is held by the floating diffusion FD to be converted into the digital signal by turning ON the transfer transistor TG, and then the pixel signal is acquired through acquisition of the difference therebetween.

In regard to the operation E2, more specifically, at a time t21 (=t31), the reset transistor RST and the transfer transistor TG of FIG. 3 are turned ON at the same time, and the photodiode PD and the floating diffusion FD are reset at the same time by the reset transistor RST and the transfer transistor TG being turned OFF immediately after the ON state to be set to a state in which accumulation of the charge can be initiated. Accordingly, as shown at a time t21 to a time t22, a pixel generated through the photoelectric conversion is accumulated in the photodiode PD by light reception occurring from the time t21 to a time t22 and the pixel signal is accumulated according to the time.

Next, at a time t22 immediately before a time t32 at which the divided exposure time Td1 obtained by dividing the preset exposure time T into two time periods passes, the selection transistor SEL is turned ON, a pixel signal formed of an analog signal is set to be converted into a digital signal by the A/D conversion circuit 101, the reset transistor RST is temporarily turned ON, the charge gradually accumulated in the floating diffusion FD is reset again by the dark current, and the reset value at this time is converted into a digital signal.

Next, at the time t32, the transfer transistor TG is turned ON, and the charge accumulated in the photodiode PD is transferred to the floating diffusion FD to be converted into a digital signal. In addition, in the A/D conversion circuit 101, a pixel signal for a half of the divided exposure time which is equal to the first half of the necessary exposure time is obtained, in which noise is cancelled through subtraction (CDS) of two values obtained in states in which the transfer transistor TG is turned ON and OFF.

Next, when the exposure is continued and the time is a time t23 immediately before a time t33 at which the divided exposure time Td1 passes, the selection transistor SEL is turned ON, a pixel signal formed of an analog signal is set to be converted into a digital signal by the A/D conversion circuit 101, the reset transistor RST is temporarily turned ON, the charge gradually accumulated in the floating diffusion FD is reset again by the dark current, and the reset value at this time is converted into a digital signal.

Next, at the time t33, the transfer transistor TG is turned ON, and the charge accumulated in the photodiode PD is transferred to the floating diffusion FD to be converted into a digital signal. In addition, in the A/D conversion circuit 101, a pixel signal at a half of the divided exposure time which is the second half of the necessary exposure time is obtained, in which noise is cancelled through subtraction (CDS) of two values obtained in states in which the transfer transistor TG is turned ON and OFF.

The pixel signal at a half of the divided exposure time which is the first half of the necessary exposure time and the pixel signal at a half of the divided exposure time which is the second half, which are obtained in the above-described manner, are accumulated in the memory unit 55 and integrated by the arithmetic circuit 54 to be output as a pixel signal with respect to the necessary exposure time. In this case, the pixel signal can be set as a pixel signal with a high dynamic range with the amount of the charge (amount of pixel signals) accumulated in the photodiode PD, which is approximately twice the charge amount of the floating diffusion FD.

Further, similarly to the operation E2, when the exposure time T is divided into four time periods by the process shown as the operation E3, it is possible to handle the pixels of four times the amount of pixels accumulated in the photodiode PD and the floating diffusion FD by repeatedly performing the process described with reference to the operation E2 four times.

In the operation E3, more specifically, at a time t41 (=t51), the reset transistor RST and the transfer transistor TG of FIG. 3 are turned ON at the same time, and the photodiode PD and the floating diffusion FD are reset at the same time by the reset transistor RST and the transfer transistor TG being turned OFF immediately after the ON state is set to a state in which accumulation of the charge can be initiated. Accordingly, at the following times, as shown in times t51 to t52, t52 to t53, t53 to t54, and t54 to t55, a pixel generated through the photoelectric conversion is accumulated in the photodiode PD by light reception occurring from the time t51 to time t55 and the pixel signal is accumulated according to the time.

Next, when the exposure is continued and the time is a time t42, t43, t44, or t45 immediately before time t52, t53, t54, or t55 respectively at which the divided exposure time Td2 obtained by dividing the necessary exposure time T into four time periods passes, the selection transistor SEL is turned ON, a pixel signal formed of an analog signal is set to be converted into a digital signal by the A/D conversion circuit 101, the reset transistor RST is temporarily turned ON, the charge gradually accumulated in the floating diffusion FD is reset again by the dark current, and the reset value at this time is converted into a digital signal.

Next, at the times t52, t53, t54, and t55, the transfer transistor TG is turned ON, and the charge accumulated in the photodiode PD is transferred to the floating diffusion FD to be converted into a digital signal. In addition, in the A/D conversion circuit 101, a pixel signal at half of the divided exposure time which is the second half with respect to the necessary exposure time is obtained, in which noise is cancelled through subtraction (CDS) of two values obtained in states in which the transfer transistor TG is turned ON and OFF.

The pixel signal at each quarter of the divided exposure time at the necessary exposure time is accumulated in the memory unit 55 in a state of being integrated by the arithmetic circuit 54 to be output as a pixel signal with respect to the necessary exposure time. In this case, the pixel signal can be set as a pixel signal with a high dynamic range with the amount of the charge (amount of pixel signals) accumulated in the photodiode PD, which is approximately four times that of the floating diffusion FD.

Image Processing

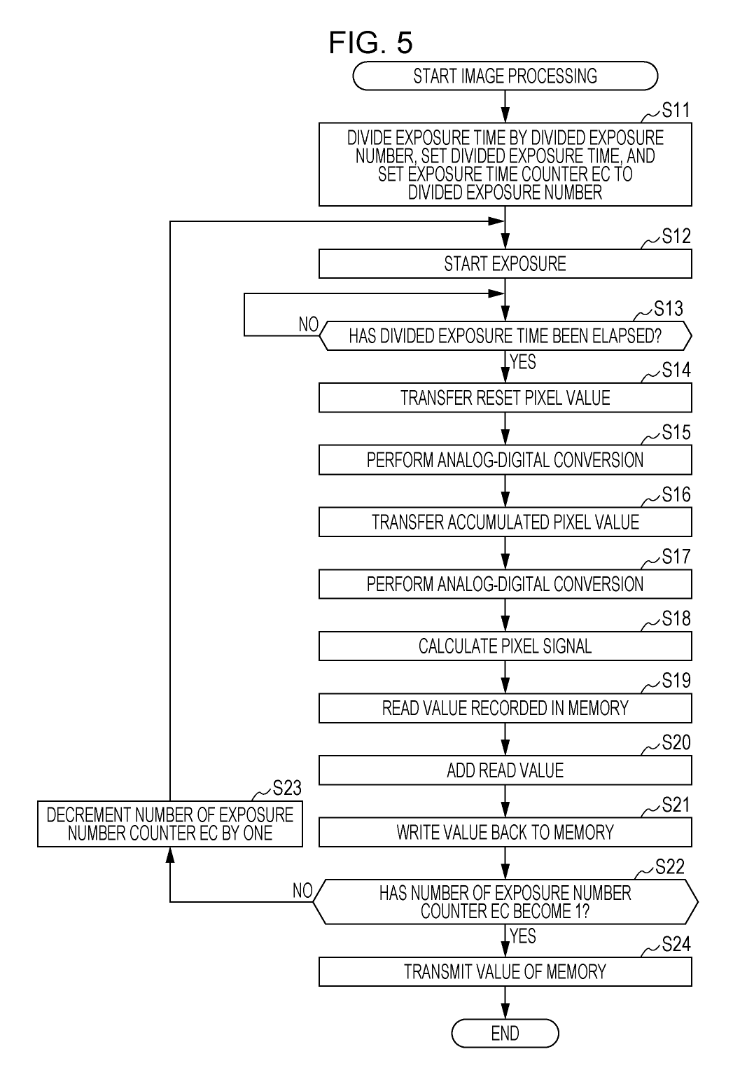

Next, the image processing will be described with reference to the flowchart of FIG. 5.

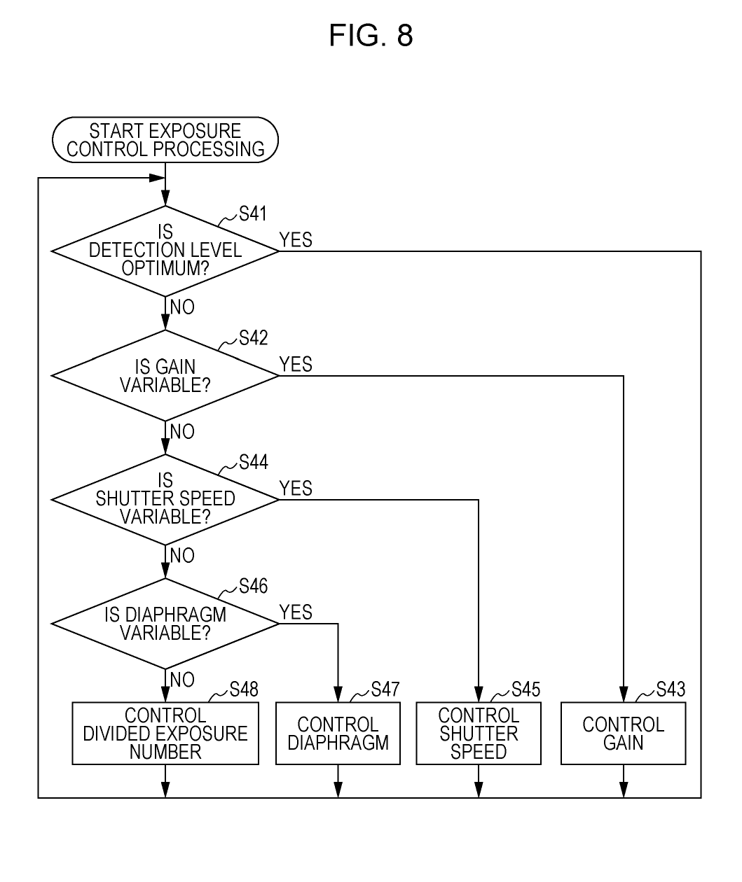

In Step S11, the camera control unit 18 calculates the necessary exposure time according to the shutter speed set based on the signal level of the pixel signal of a previous frame supplied from the signal level detecting unit 17, sets the divided exposure time by dividing the exposure time by the number of times of division exposure, and sets the exposure time counter EC to the number of times of division exposure. At this time, the camera control unit 18 sets an appropriate gain, shutter speed, opening degree of a diaphragm, and number of times of division exposure of the exposure time by performing a process described later with reference to FIG. 8 when the necessary exposure time is calculated. Further, in the initial process, since the previous pixel signal is not present, a predetermined signal level may be set as a default value.

In Step S12, the camera control unit 18 supplies the control signal to the diaphragm driving unit 12 to control the diaphragm mechanism unit 11 to have a set opening degree. Further, the camera control unit 18 supplies the set value necessary for timing generation with respect to the imaging element 14. The timing generation unit 51 generates a timing signal for starting light reception and supplies the signal to each of the light receiving elements P of the light receiving element array 52. In addition, each of the light receiving elements P of the light receiving element array 52 starts light reception according to the timing signal.

More specifically, the timing generation unit 51 releases the remaining charge to be reset by controlling the reset transistor RST and the transfer transistor TG to be ON simultaneously for an extremely short period of time based on the set value from the camera control unit 18. The charge accumulated in the photodiode PD and the floating diffusion FD is reset due to the process and the charge accumulation is made possible.

In Step S13, the timing generation unit 51 determines whether the divided exposure time has passed, and if not, the same process is repeatedly performed until the time has passed. Further, in Step S13, when it is considered that the divided exposure time has passed, the process advances to Step S14.

In Step S14, the timing generation unit 51 controls the selection transistor SEL to be ON, controls the reset transistor RST to be ON for an extremely short period of time, and makes the charge transferable to the A/D conversion circuit 101. Further, the timing generation unit 51 controls the reset transistor RST to be ON for an extremely short period of time, amplifies a signal by the charge accumulated in the floating diffusion FD due to the dark current through the amplifier transistor AMP, and transfers the signal to the A/D conversion circuit 101 as a reset signal. That is, the pixel value in a reset state is transferred.

In Step S15, the A/D conversion circuit 53 (A/D conversion circuit 101) converts the supplied pixel signal from the analog signal to the digital signal and holds the converted signal in the A/D conversion circuit 53 as a negative value. That is, by this process, the reset signal formed of only the switch noise generated due to the dark current is held in the A/D conversion circuit 53 as a negative value.

In Step S16, the timing generation unit 51 controls the transfer transistor TG to be ON and transfers the charge accumulated in the photodiode PD to the floating diffusion FD. At this time, since the selection transistor SEL is ON, the charge accumulated in the floating diffusion FD is transferred to the A/D conversion circuit 101 as a pixel signal amplified through the amplifier transistor AMP. That is, the accumulated pixel value is transferred.

In Step S17, the A/D conversion circuit 53 (A/D conversion circuit 101) converts the supplied pixel signal into a digital signal from an analog signal as a positive value. That is, the pixel signal corresponding to the charge accumulated in the photodiode PD including the switch noise generated due to the dark current is converted as a positive value through this process.

In Step S18, the A/D conversion circuit 53 (A/D conversion circuit 101) calculates the pixel signal which makes the switch noise be cancelled by continuously converting the reset signal held as a negative value formed of only the switch noise and the A/D converted pixel signal as a positive value corresponding to the charge accumulated in the photodiode PD including the switch noise.

In Step S19, the arithmetic circuit 54 reads the pixel signal stored in the memory unit 55. Further, in the case of first exposure, since the pixel signal stored in the memory unit 55 is not present, the process of Step S19 may be skipped.

In Step S20, the arithmetic circuit 54 adds the pixel signal read from the memory unit 55 to the pixel signal acquired through calculation such that the switch noise is cancelled. In the case of first exposure, since the pixel signal stored in the memory unit 55 is not present, the process of Step S20 may be also skipped similarly to the process of Step S19.

In Step S21, the arithmetic circuit 54 writes the pixel signal which is the result of addition between the read pixel signal and the pixel signal acquired by calculation back to the memory unit 55 to be stored.

In regard to the process of Step S21, in a case where exposure is the first time exposure and the processes of Steps S19 and S20 are skipped, since the pixel signal acquired by calculation is not present, the A/D conversion circuit 53 (A/D conversion circuit 101) transfers the pixel signal directly to the memory unit 55 to be stored without transferring the signal through the arithmetic circuit 54.

In Step S22, the timing generation unit 51 determines whether the exposure time counter EC is 1. Here, since the number of times of division exposure is the number of times of division of the necessary exposure time, when the exposure time counter EC of the initial process is 1, this means that the exposure time has not been substantially divided. In Step S22, in a case where the process is the initial process and the number of times of division exposure is one, since it is considered that the exposure time has not been substantially divided, the process advances to Step S24. Meanwhile, in Step S22, when it is considered that the exposure time counter EC is not 1, the process advances to Step S23.

In Step S23, the timing generation unit 51 decrements the exposure time counter EC by 1 and the process returns to Step S12. That is, in Step S22, the processes of Steps S21 to S23 are repeated by the number of times of division exposure until the exposure time counter EC becomes 1. Further, in Step S23, when it is considered that the exposure time counter EC becomes 1, the process advances to Step S24.

In Step S24, the timing generation unit 51 supplies the control signal for transferring the pixel signal accumulated in the memory unit 55 to the imaging element 14 as a pixel signal for one frame and controls the transmission unit 56 such that the pixel signal accumulated in the memory unit 55 to be read and transferred as a pixel signal for one frame.

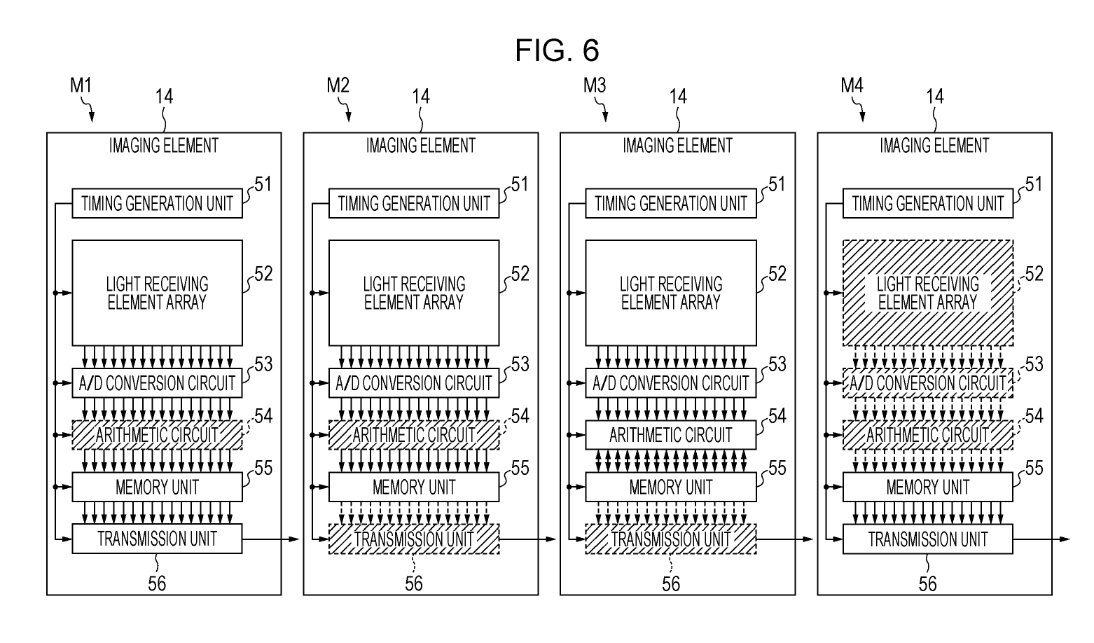

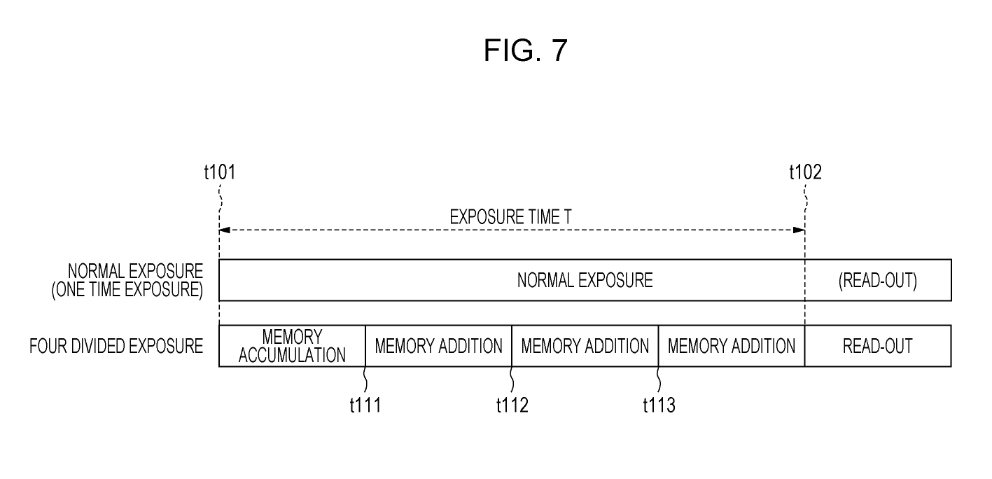

That is, in the imaging element 14 in general, as shown in a state M1 of FIG. 6, an exposure time is set as a necessary exposure time T as shown at a time t101 to t102 of the upper stage of FIG. 7, by the timing generation unit 51, and the charge which becomes a pixel signal is accumulated in the light receiving element array 52 within the exposure time T only by once. Further, the pixel signal is read from the light receiving element array 52 at the timing of a time t102, converted to the digital signal by the A/D conversion circuit 53, the converted pixel signal passes through the arithmetic circuit 54 to be supplied to the memory unit 55, and the transmission unit 56 outputs the pixel signal stored in the memory unit 55. Further, in FIG. 6, oblique lines are added in the configuration in which the operation is stopped among the timing generation unit 51 to the transmission unit 56.

Meanwhile, in the case of the process described with reference to the flowchart of FIG. 5, for example, the operation shown in a state M2 of FIG. 6 is performed by the processes of Step S12 to S21 (in this case, the processes of Steps S19 and S20 are skipped, and the pixel signal calculated by the A/D conversion circuit 53 (A/D conversion circuit 101) are directly transferred to the memory unit 55 bypassing the arithmetic circuit 54 and then stored in Step S21) when the number of times of division exposure is four. That is, in the initial divided exposure time obtained by dividing the necessary exposure time into four time periods as shown at times t101 to t111 in the lower stages of FIG. 7, the charge is accumulated in the light receiving element array 52 to be output to the A/D conversion circuit 53, and the pixel signal is converted into the digital signal by the A/D conversion circuit 53 to be accumulated in the memory unit 55.

In addition, as shown at times t111 to t112, t112 to t113, and t113 to t114 in the lower stages of FIG. 7, the operation as shown in the state M3 of FIG. 6 is performed by the processes of Steps S12 to S23 at the time subsequent to the initial divided exposure time obtained by dividing the exposure time T into four time periods. That is, the charge is accumulated in the light receiving element array 52 to be output to the A/D conversion circuit 53, and the process in which the pixel signal converted into the digital signal by the A/D conversion circuit 53 and the pixel signal accumulated in the memory unit 55 are added to each other, and then the result is accumulated therein again is repeated.

When the exposure time T is completed, as shown in a state M4 of FIG. 6, the pixel signal stored in the memory unit 55 is transmitted by the transmission unit 56 through the process of Step S24 at the timing of the time t102 in the lower stage of FIG. 7.

By performing the above-described processes, generation of the pixel signal becomes possible by dividing the exposure time within the necessary exposure time and repeatedly accumulating signals generated by the imaging element 14 during the divided exposure time period. Accordingly, it is possible to set a saturated signal amount which is several times the number of division with respect to the saturated signal amount of the charge to be accumulated by the light receiving element constituting the imaging element 14.

As a result, in a case of imaging a bright scene, it is possible to appropriately image an image with a high dynamic range without mounting an ND filter. Further, since it is possible to image in a state in which ISO sensitivity to be adjusted by decreasing the gain is decreased, imaging in a state in which the diaphragm is set on a release side becomes possible, and imaging with so-called blur and a shallow depth of field becomes possible even in a bright scene.

Exposure Control Processing

Next, exposure control processing will be described with reference to the flowchart of FIG. 8. Further, here, a case in which the priority of operations to be controlled is set in order of a gain, a shutter speed, a diaphragm, and the number of times of division exposure when a signal level is extremely high is described, but the priority may not be limited thereto.

In Step S41, the camera control unit 18 determines whether a signal level of a previous pixel signal to be supplied from the signal level detecting unit 17 is an optimum level. In Step S41, for example, in a case where it is determined that the signal level is not optimum, the process advances to Step S42.

In Step S42, the camera control unit 18 determines whether the gain of the imaging element 14 can be controlled to be variable. That is, the camera control unit 18 determines whether control for decreasing the gain for decreasing the signal level is possible in a case where the signal level is extremely high or whether control for increasing the gain is possible and control for increasing the signal level using the shutter speed, the diaphragm, or the number of times of division exposure is not possible in a case where the signal level is extremely low. That is, here, when the signal level is extremely high, the priority to be controlled is set in order of the gain, the shutter speed, the diaphragm, and the number of times of division exposure. Accordingly, when the signal level is extremely low, since the priority becomes reversed, control using the shutter speed or the diaphragm is prioritized even when the control using the gain is possible. In a case where it is determined that the gain can be controlled to be variable in Step S42, the camera control unit 18 performs adjustment on the gain to be increased or decreased as necessary according to the signal level in Step S43.

In Step S42, when it is determined that adjustment on the gain to be increased or decreased is not possible for adjustment on the signal level, the process advances to Step S44.

In Step S44, the camera control unit 18 determines whether the shutter speed of the imaging element 14 can be controlled to be variable. That is, the camera control unit 18 determines whether control for increasing the shutter speed for decreasing the signal level is possible in the case where the signal level is extremely high or whether control for decreasing the shutter speed for increasing the signal level is possible in the case where the signal level is extremely low. In this case, the control for increasing the signal level using the diaphragm or the number of times of division exposure is not possible when the signal level is extremely low, accordingly, it is determined that control using the shutter speed is possible. In the case where it is determined that the shutter speed can be controlled to be variable in Step S44, the camera control unit 18 performs adjustment for increasing or decreasing the shutter speed as necessary according to the signal level in Step S45.

In Step S44, in the case where it is determined that adjustment for increasing or decreasing the shutter speed for adjusting the signal level is not possible, the process advances to Step S46.

In Step S46, the camera control unit 18 determines whether the opening degree of the diaphragm mechanism unit 11 can be controlled to be variable. That is, the camera control unit 18 determines whether control for decreasing the opening degree of the diaphragm mechanism unit 11 for decreasing the signal level is possible in the case where the signal level is extremely high or whether control for increasing the opening degree of the diaphragm mechanism unit 11 for increasing the signal level is possible in the case where the signal level is extremely low. In this case, the control for increasing the signal level using the number of times of division exposure is not possible when the signal level is extremely low, accordingly, it is determined that control using the diaphragm is possible.

In the case where it is determined that the opening degree of the diaphragm mechanism unit 11 can be controlled to be variable in Step S46, the camera control unit 18 performs adjustment for increasing or decreasing the opening degree of the diaphragm mechanism unit 11 as necessary according to the signal level in Step S47.

In Step S46, in the case where it is determined that adjustment for increasing or decreasing the opening degree of the diaphragm mechanism unit 11 for adjusting the signal level is not possible, the process advances to Step S48.

In Step S48, the camera control unit 18 controls the number of times of division exposure of the necessary exposure time according to the signal level. That is, when the signal level is extremely high, the camera control unit 18 increases the number of times of division exposure of the necessary exposure time such that the saturated signal amount is increased. Further, when the signal level is extremely low, the camera control unit 18 decreases the number of times of division exposure of the necessary exposure time such that the saturated signal amount is decreased.

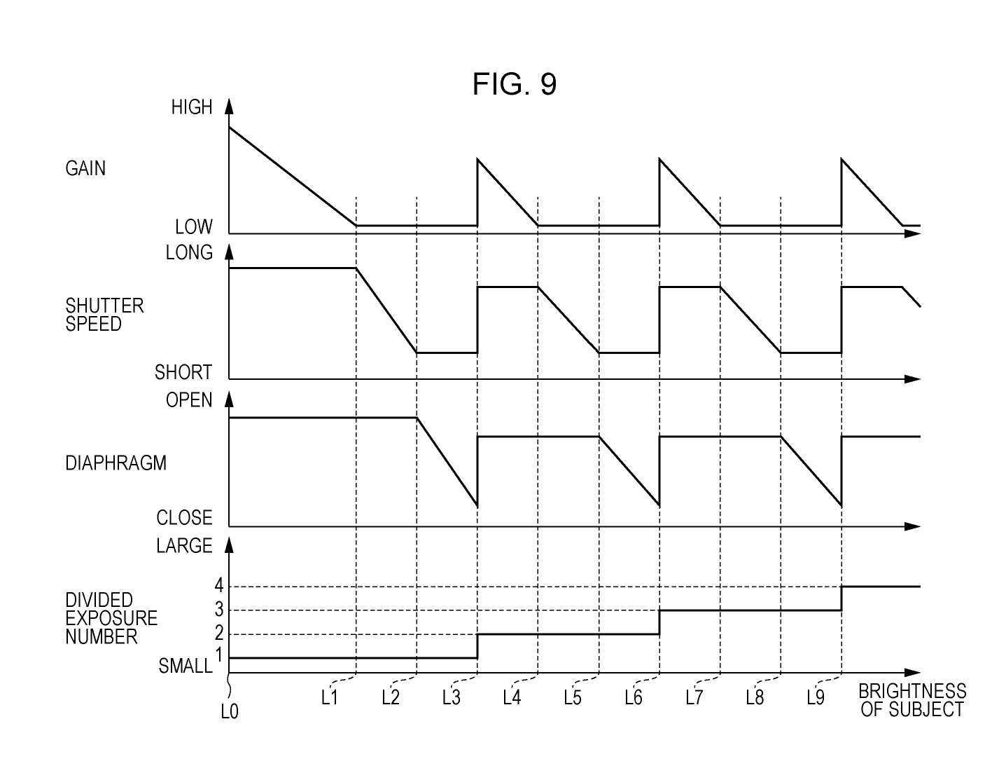

The relationship as shown in FIG. 9 is set when the above-described processes are summarized. Further, in FIG. 9, the horizontal axis represents the brightness and the vertical axis represents the gain, the shutter speed, the opening degree of the diaphragm mechanism unit 11, and the number of times of division exposure from the top stage.

That is, in a case where the signal level is indicated by a signal level L0 or L1, the number of times of division exposure is 1, which is the lowest number, and the signal level is extremely high, firstly, the gain is gradually decreased and becomes uncontrollable when the signal level of the gain becomes L1, which is the lowest limit to be set.

Next, in the case where the signal level is the signal level L1 or L2, the shutter speed becomes gradually higher and the release time becomes shorter. Further, in the case where the signal level is the signal level L2, the shutter speed becomes uncontrollable.

Further, in the case where the signal level is the signal level L2 or L3, the opening degree of the diaphragm mechanism unit 11 is getting gradually closed. Further, in the case where the signal level is the signal level L3, the opening degree of the diaphragm mechanism unit 11 becomes uncontrollable.

Furthermore, in the case where the signal level is the signal level L3, the number of times of division exposure becomes 2 by being increased from 1. As a result, since the saturated signal amount becomes substantially double, the gain, the shutter speed, and the diaphragm can be controlled again when the signal level becomes higher than the signal level L3.

Here, in the case where the signal level is the signal level L3 or L4, the number of times of division exposure is 2, and the gain is controlled again when the signal level is extremely high. Further, when it is considered that the gain is uncontrollable in the signal level L4, the shutter speed becomes gradually increased and the release time becomes shorter in the case where the signal level is the signal level L4 or L5. Further, the shutter speed becomes uncontrollable in the case where the signal level is the signal level L5, and the opening degree of the diaphragm mechanism unit 11 is getting gradually closed in the case where the signal level is the signal level L5 or L6. Further, in the case where the signal level is the signal level L6, the number of times of division exposure becomes 3 by being increased from 2. Hereinafter, the same process of controlling is performed in accordance with the increase of the signal level.

In other words, when the signal level is extremely high, the saturated signal amount can be changed by increasing the number of times of division exposure of the exposure time. Further, the example of changing the setting in order of the gain, the shutter speed, and the diaphragm has been described in the description above, but the order is not limited thereto or any of parameters may be fixed. As a result, a degree of freedom for setting the gain, the shutter speed, and the diaphragm can be increased.

Further, the example of generating the pixel signal of the necessary exposure time by converting the pixel signal generated by the light receiving element into the digital signal at the divided exposure time obtained by dividing the necessary exposure time and then adding the signal has been described in the description above, but the pixel signal generated by the light receiving element at the divided exposure time may added as the analog signal so that the pixel signal of the necessary exposure time is generated. Moreover, in the above description, the example of evenly dividing the necessary exposure time has been described, but the divided exposure time may not be necessarily evenly divided and may be unevenly divided as long as the integration time of the divided exposure time is the necessary exposure time.

By performing the above-described processes, since the saturated signal amount can be changed by controlling the number of times of division exposure of the exposure time according to the signal level, it is possible to image an image with a high dynamic range even in the case of imaging a bright scene. Further, it is possible to image using a low gain (low ISO sensitivity) without mounting an ND filter.

On the other hand, the series of processes described above can be allowed to be executed by software as well as hardware. A program constituting the software is installed from a recording medium to a computer in which dedicated hardware is incorporated or a general-purpose personal computer which can perform various functions by installing various programs therein in a case where a series of processes are executed by the software.

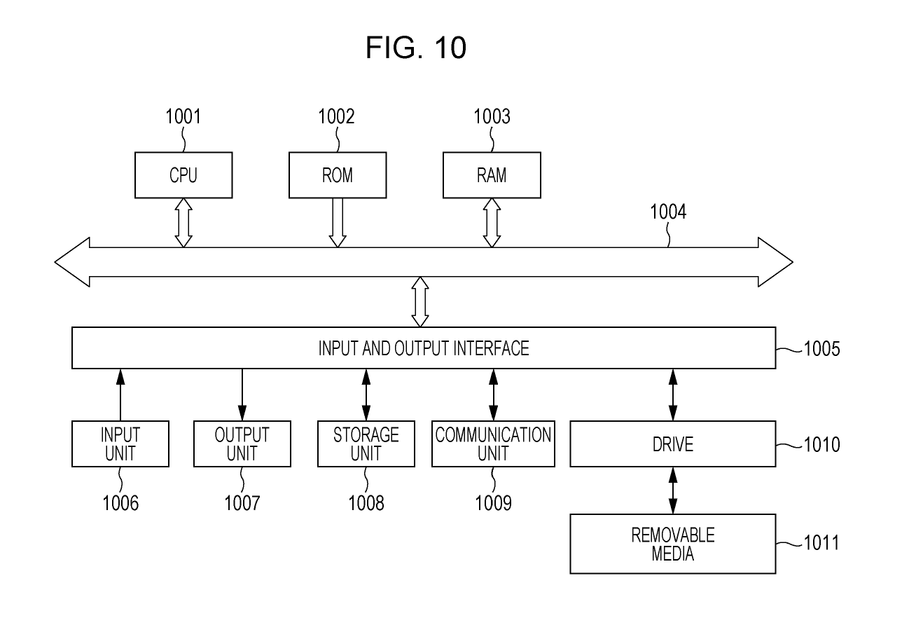

FIG. 10 shows a configuration example of a general-purpose personal computer. The personal computer has a Central Processing Unit (CPU) 1001 incorporated therein. An input and output interface 1005 is connected to the CPU 1001 through a bus 1004. A Read Only Memory (ROM) 1002 and a Random Access Memory (RAM) 1003 are connected to the bus 1004.

A keyboard to which an operation command is input by a user, an input unit 1006 formed of an input device such as a mouse, an output unit 1007 which outputs an image of a processing operation screen or a processing result to a display device, a storage unit 1008 formed of a hard disk drive or the like that stores programs or various pieces of data, and a communication unit 1009 that is formed of a Local Area Network (LAN) adaptor and performs communication processing through a network represented by the Internet are connected to the input and output interface 1005. Further, a drive 1010 that reads and writes data with respect to removable medium 1011 such as a magnetic disc (including a flexible disc), an optical disc (including a Compact Disc-Read Only Memory (CD-ROM) and a Digital Versatile Disc (DVD)), a magneto-optical disc (including Mini Disc (MD)), and a semiconductor memory is connected thereto.

The CPU 1001 executes various programs according to a program stored in the ROM 1002 or programs read by the removable medium 1011 such as a magnetic disc, an optical disc, a magneto-optical disc, and a semiconductor memory, installed in the storage unit 1008, and then downloaded to the RAM 1003 from the storage unit 1008. Further, data necessary for executing various processes by the CPU 1001 is appropriately stored in the RAM 1003.

In the computer configured in the above-described manner, the series of processes described above are carried out by the CPU 1001 executing programs stored in the storage unit 1008 to be downloaded to the RAM 1003 through the input and output interface 1005 and the bus 1004.

Programs executed by the computer (CPU 1001) can be provided by being recorded in the removable medium 1011 as package media or the like. Further, the programs can be provided through a wired or wireless transmission medium such as a local area network, the Internet, and a digital satellite broadcasting.

In the computer, programs can be installed in the storage unit 1008 through the input and output interface 1005 by mounding the removable medium 1011 on the drive 1010. In addition, the programs can be installed in the storage unit 1008 by being received in the communication unit 1009 through a wired or wireless transmission medium. In addition, programs can be installed in the ROM 1002 or the storage unit 1008 in advance.

In addition, the programs executed by the computer may be programs in which processes are performed in time series according to the procedures described in the present specification and/or programs in which processes are performed in the necessary timing when a call is made or the like.

In addition, in the present specification, the system means aggregation of a plurality of constituent components (devices, modules (components), and the like) and all constituent components are not necessarily included in the same housing. Therefore, both of a plurality of devices accommodated in separate housings and connected through a network or one device in which a plurality of modules are accommodated in one housing are systems.

In addition, the embodiments of the present technology are not limited to the above-described embodiments and various modifications are possible within the range not departing from the scope of the present technology. For example, the present technology may employ cloud computing in which one function is processed by being shared and cooperated by a plurality of devices through a network.

Further, each step described in the flowcharts above can be performed by one device or a plurality of devices in a cooperative manner. Furthermore, in a case where a plurality of processes are included in one step, the plurality of processes included in one step can be performed by one device or a plurality of devices in a cooperative manner.

In addition, the present technology may employ the following configurations:

(1) An image sensor including: an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which is necessary for imaging an image into multiple time periods, and the accumulation unit accumulates the pixel signal generated by the imaging element and outputs the pixel signal accumulated in the necessary exposure time.

(2) The image sensor according to (1), further including a conversion unit that converts the pixel signal formed of an analog signal output by the imaging element into a digital signal, in which the accumulation unit accumulates the pixel signal converted into the digital signal by the conversion unit.

(3) The image sensor according to (2), further including an arithmetic unit that reads the pixel signal accumulated in the accumulation unit, adds the pixel signal converted into the digital signal by the conversion unit to the read pixel signal, and writes the pixel signal back to the accumulation unit when the pixel signal is generated by the imaging element for each of the divided exposure times.

(4) The image sensor according to any one of (1) to (3), further including a divided exposure frequency determining unit that determines the number of times of the division exposure based on a signal level of the pixel signal output by the accumulation unit.

(5) The image sensor according to (4), in which the divided exposure frequency determining unit increases the number of times of the division exposure when the signal level of the pixel signal output from the accumulation unit is saturated in a case where a gain that amplifies the pixel signal is controlled to be minimum, the exposure time is controlled to be shortest, and a diaphragm is controlled to be minimum.

(6) The image sensor according to (1), wherein the exposure is successively continued as a whole with each of the divided exposure time.

(7) A method of operating an image sensor which includes an imaging element that generates a pixel signal through photoelectric conversion with a variable exposure time, and an accumulation unit that accumulates the pixel signal generated by the imaging element, the method including: causing the imaging element to repeatedly generate the pixel signal through the photoelectric conversion for each of divided exposure time periods obtained by dividing a necessary exposure time which is necessary for imaging an image into multiple time periods; and causing the accumulation unit to accumulate the pixel signal generated by the imaging element and output the pixel signal accumulated in the necessary exposure time.

(8) An imaging apparatus including: an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of divided exposure time periods obtained by dividing a necessary exposure time which is necessary for imaging an image into multiple time periods, and the accumulation unit accumulates the pixel signal generated by the imaging element and outputs the pixel signal accumulated in the necessary exposure time.

It should be understood by those skilled in the art that various modifications, combinations, sub-combinations and alterations may occur depending on design requirements and other factors insofar as they are within the scope of the appended claims or the equivalents thereof.

What is claimed is:

1. An image sensor comprising:
an imaging element that generates a pixel signal through photoelectric conversion with a variable exposure time; and
an accumulation unit that accumulates the pixel signal generated by the imaging element,
wherein the imaging element repeatedly generates the pixel signal through the photoelectric conversion for each of the divided exposure time periods obtained by dividing a necessary exposure time which is necessary for imaging an image into multiple time periods, and
the accumulation unit accumulates the pixel signal generated by the imaging element and outputs the pixel signal accumulated in the necessary exposure time.

2. The image sensor according to claim 1, further comprising a conversion unit that converts the pixel signal formed of an analog signal output by the imaging element into a digital signal,
wherein the accumulation unit accumulates the pixel signal converted into the digital signal by the conversion unit.

3. The image sensor according to claim 2, further comprising an arithmetic unit that reads the pixel signal accumulated in the accumulation unit, adds the pixel signal converted into the digital signal by the conversion unit to the read pixel signal, and writes the pixel signal back to the accumulation unit when the pixel signal is generated by the imaging element for each of the divided exposure times.

4. The image sensor according to claim 1, further comprising a divided exposure frequency determining unit that determines the number of times of the division exposure based on a signal level of the pixel signal output by the accumulation unit.

5. The image sensor according to claim 4, wherein the divided exposure frequency determining unit increases the number of times of the division exposure when the signal level of the pixel signal output from the accumulation unit is saturated in a case where a gain that amplifies the pixel signal is controlled to be minimum, the exposure time is controlled to be shortest, and a diaphragm is controlled to be minimum.

6. The image sensor according to claim 1, wherein the exposure is successively continued as a whole with each of the divided exposure time.

7. A method of operating an image sensor which includes an imaging element that generates a pixel signal through photoelectric conversion with a variable exposure time, and an accumulation unit that accumulates the pixel signal generated by the imaging element, the method comprising:
causing the imaging element to repeatedly generate the pixel signal through the photoelectric conversion for each of divided exposure time periods obtained by dividing a necessary exposure time which is necessary for imaging an image into multiple time periods; and
causing the accumulation unit to accumulate the pixel signal generated by the imaging element and output the pixel signal accumulated in the necessary exposure time.

8. An imaging apparatus comprising:
an imaging element that generates a pixel signal through photoelectric conversion with a variable exposure time; and
an accumulation unit that accumulates the pixel signal generated by the imaging element,
wherein the imaging element repeatedly generates the pixel signal through the photoelectric conversion for each of the divided exposure time periods obtained by dividing a necessary exposure time which is necessary for imaging an image into multiple time periods, and
the accumulation unit accumulates the pixel signal generated by the imaging element and outputs the pixel signal accumulated in the necessary exposure time.
